(19) United States
(12) Patent Application Publication
(10) Pub. No.: US 2019/0045957 A1
(43) Pub. Date: Feb. 14, 2019

(54) Food Carrier System

(71) Applicant: YourGreen2Go Inc., Spring, TX (US)

(72) Inventor: Scott Patterson, Spring, TX (US)

(73) Assignee: YourGreen2Go Inc., Spring, TX (US)

(21) Appl. No.: 15/815,275

(22) Filed: Nov. 16, 2017

Related U.S. Application Data
(63) Continuation-in-part of application No. 29/613,212, filed on Aug. 8, 2017.

(51) Int. Cl. A47G 23/06; B65D 21/02; B65D 43/02; A47J 47/02

(52) U.S. Cl. CPC A47G 23/06; A47J 47/02; B65D 43/02; B65D 21/0233

(57) ABSTRACT

A food carrier system including a food carrier and one or more food containers. The food carrier having a base portion and a lid portion, where the lid portion can include one or more lid wells. Each lid well can include one or more tiers, each tier configured to receive a food container having a preferred size and dimension. The base portion can include one or more base wells, also configured to receive one or more food containers. The lid portion and base portion can be secured to one another by way of a securing mechanism.

### BACKGROUND OF FOOD CARRIER SYSTEM

### Field of the Food Carrier System

This food carrier system relates to food carriers. In particular, this food carrier system relates to food carrier delivery system with a lid and tray and with interchangeable containers.

### Description of Related Art

Food delivery has greatly increased in popularity in recent years. However, industries from home food delivery to hotel “room service” rely on delivery systems and containers that have been around for decades. For example, hotel room service still relies on reusable dinnerware that often sits in the hallway for hours after use, and must be collected and washed before reuse. Because of tight regulations, many states require those dishes must be picked up by designated personnel, washed by designated dish washer personnel, and dishes often become broken or go missing during the process. All of these factors contribute to costs that are so high, room service is rarely profitable for the hotel. However, room service has become a luxury service expected by hotel guests, and certain hotels insist on keeping this service in order to stay competitive in the market. Therefore, a need exists for a food delivery system that is both convenient and economical for hotels and other food deliverers. Moreover, a need exists for a food carrier that is “green,” being made of compostable and/or recyclable material to be more environmentally friendly.

### SUMMARY OF THE FOOD CARRIER SYSTEM

The food carrier system described herein includes a carrier for transporting and serving food stuffs, adding tremendous benefit to the room service and food delivery industries.

One aspect of the food carrier system is to provide a food carrier able to keep food items separate during plating and delivery of a meal. More particularly, the food carrier provides a means to keep “hot dishes” separate from “cold dishes,” providing a means to store hot dishes within the base portion of the food carrier and cold dishes within the lid portion of the food carrier, or vice versa. The lid portion is configured to removably attach to the base portion so that a delivery person can hold the food carrier at one or two contact positions for delivering or transporting the food carrier.

Another aspect of the present food carrier system is to provide a food carrier for transporting food within the container in designated interior container wells. The food carrier base portion includes a substantially flat tray configured to secure one or more food containers therein. The food carrier base portion can include one or more partitions for securing and separating the one or more food containers disposed therein. The food containers are interchangeable so that a food preparer can select an appropriately sized food container for a requested dish. Thereby, the interior container wells are configured to hold and secure whichever food container the food preparer chooses.

Another aspect of the food carrier system is a lid portion that is configured to be removably coupled to the base portion such that the lid secures the contents of the interior of the food carrier while providing additional container wells to secure one or more food containers for transportation. The lid defines container wells for the food containers such that the food containers remain secured and upright during transit. In another aspect, the lid also defines one or more sauce container wells for securing one or more sauce containers.

Another aspect of the food carrier system includes a plurality of tabs disposed about the lip or edge of any one of the containers. The tabs define a means for a user to secure the lid portion of the container to the base portion of the container. The tab defines a gripping piece for maneuvering the lid on and off of the base portion and further defines an inner tab portion for engaging a lip of the base portion.

Additional aspects of the food carrier system include methods of making and using food carriers in accordance with the foregoing aspects. It should also be noted that the food carrier system further encompasses the various possible combinations of the aspects and features disclosed herein.

### BRIEF DESCRIPTION OF THE SEVERAL VIEWS OF THE DRAWING(S)

The accompanying drawings illustrate various exemplary implementations and are part of the specification. The illustrated implementations are proffered for purpose of example, not for purpose of limitation.

Illustrated elements will be designated by numbers. Once designated, an element will be identified by the identical number throughout. Illustrated in the accompanying drawings is at least one of the best mode embodiments of the present disclosure. In such drawings:

FIG. 1 depicts a perspective view of the lid and base portions of the food carrier, as discussed and described herein.

FIG. 2a depicts a perspective view of the lid of the food carrier, as discussed and described herein.

FIG. 2b depicts a bottom side view of the lid portion of the food carrier, as discussed and described herein.

FIG. 2c depicts a cross sectional view of the lid portion, with the cross section taken through a lid well, as discussed and described here.

FIG. 3a depicts a lid portion having a sauce cup and a first food container disclosed thereon, as discussed and described here.

FIG. 3b depicts a lid portion having a sauce cup and a second food container disclosed thereon, as discussed and described herein.

FIG. 3c depicts a lid portion having a sauce cup and a third food container disclosed thereon, as discussed and described herein.

FIG. 4 depicts the base portion of the food carrier, as discussed and described herein.

FIG. 5 depicts a cross sectional view of the base portion of the food carrier, as discussed and described herein.

FIGS. 6a through 6d depict a variety of food containers sized and shaped for the food carrier, as discussed and described herein.

FIG. 7 depicts a lid portion and a base portion connected by a securing mechanism, as discussed and described herein.

FIG. 8a depicts a cross sectional view of a securing mechanism in an unlocked position, as discussed and described herein.

FIG. 8b depicts a cross sectional view of a securing mechanism in a locked position, as discussed and described herein.

### DETAILED DESCRIPTION

A food carrier system for food storage, transportation, delivery, and consumption is disclosed herein. The food carrier system includes a food carrier and a plurality of exchangeable food containers suitable for delivery of food to a consumer. The food carrier described herein is best suited for food delivery industries, including room service in hotels and carry out delivery for restaurants. The food carrier system is designed, in part, to deliver a meal to an end consumer by providing adequately sized food containers for each dish, and a food carrier to accommodate the food containers in a way that is both convenient and sensical to the food preparer, the food deliverer, and the food consumer.

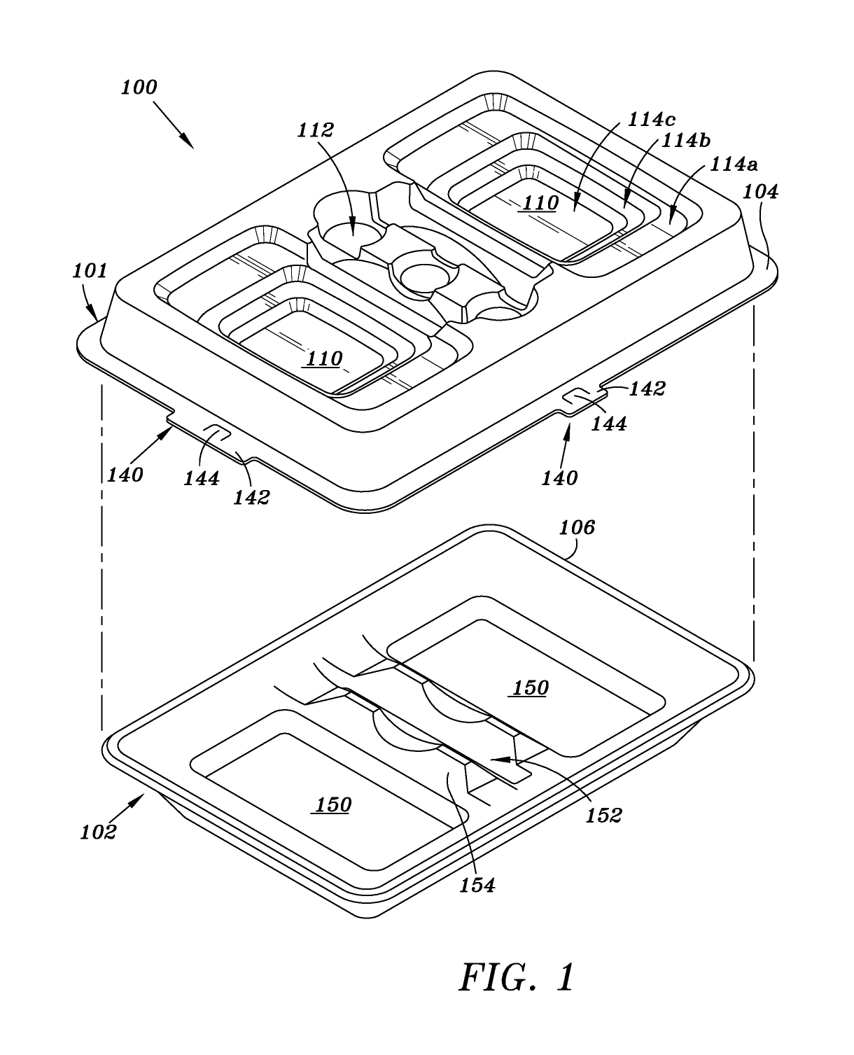

Referring to FIG. 1, the food carrier 100 described herein includes a lid portion 101 and a base portion 102. The lid portion 101 can include one or more lid wells 110 (two are shown), one or more sauce cup wells 112 (three are shown), one or more securing mechanisms 140 (two are shown), or any combination thereof. The securing mechanism 140 can include a separation tab 142 and a lock tab 144. One or more of the lid wells 112 can include one or more tiers 114, or levels, within the main body of the lid well 110. More particularly, as an example, a lid well having three tiers can include a top tier 114a, a middle tier 114b, and a bottom tier 114c. The lid wells 110 and/or sauce cup wells 112 can be defined by a depression in the top surface of the lid portion having one or more partitions disposed therebetween.

The base portion 102 can include one or more base wells 150 (two are shown) and/or one or more utensil wells 152. Though not shown, the base wells 150 can include one or more tiers within the main body of the base portion 102. The base wells 150 and/or utensils wells 152 can be defined by the raised side walls of the base portion 102 and/or one or more partitions 154 disposed therebetween.

The lid portion 101 and the base portion 102 can be configured to electively connect to one another by aligning the lid rim 104 and the base rim 106. One more of the securing mechanisms 140 disposed on the lid rim 104 can be used to connect the lid portion 101 to the base portion 102.

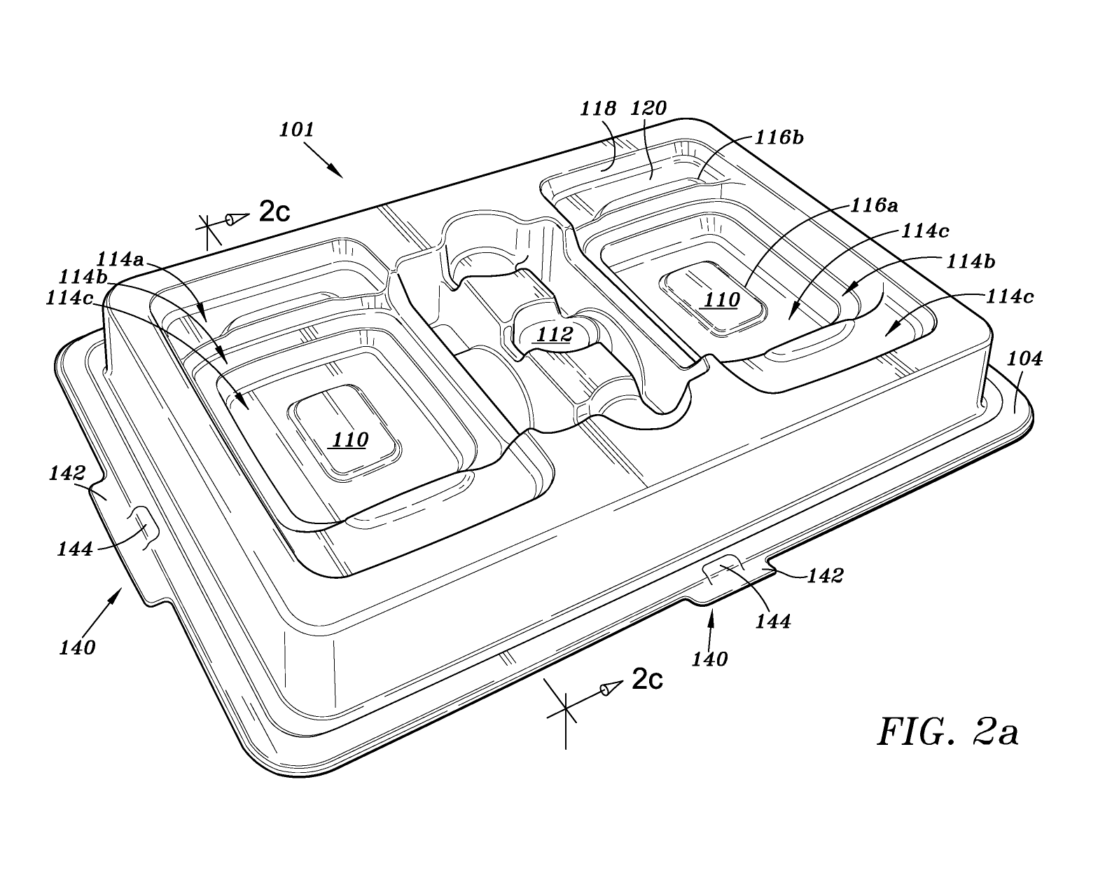

FIG. 2a depicts a perspective view of the lid of the food carrier 100. FIG. 2b depicts a bottom side view, or an “upside down” view, of the lid portion 101 of the food carrier 100. Though the lid portion 101 is intended to be used in its “right-side up” position (as shown in FIG. 2a), the bottom side view of FIG. 2b might allow a reader to better see and understand the depressions formed in the lid portion 101, and has therefore been included for that purpose. FIG. 2c depicts a cross sectional view of the lid portion 101, with the cross section taken through a lid well 110 as indicated by FIG. 2a.

In the embedment depicted in the Figures, the lid portion 101 contains two lid wells 110, each having three tiers: the top tier 114a, the middle tier 114b, and the bottom tier 114c. As best depicted in FIG. 2c, each tier 114 can be defined by the combination of a sidewall and a bottom surface within a single plane and configured to receive a single food container therein. In any embodiment have more than one tier, the tier may be defined by at least a partial side wall and at least a partial bottom surface about a single horizontal plane. In such a multi-tiered embodiment, the at least a partial sidewall 118 is configured to engage at least a portion of the side walls of a food container and at least a partial bottom surface 120 is configured to engage at least a portion of the bottom surface of said food container in such a way that the food container is prevented from sliding horizontally, especially during transit of the food carrier 100.

It should be understood that varying embodiments can include lid wells 110 having a plurality of tiers. For example, each lid well 110 can have one tier, two tiers, three tiers, four tiers, five tiers, six tiers, seven tiers, eight tiers, nine tiers, or ten tiers. In another example, each lid well 110 can have one or more tiers, two or more tiers, three or more tiers, four or more tiers, five or more tiers, six or more tiers, seven or more tiers, eight or more tiers, nine or more tiers, or ten or more tiers. Further, in an embodiment of the lid portion 101 having two or more lid wells, each lid well can include a separately elected number of tiers. For example, in an embodiment where the lid well has two lid wells, the first lid well can have two tiers and the second lid well can have five tiers. The lid portion 101 can also include one or more stability depressions 124 (two are shown). The stability depressions can provide a variety of functions, including added stability and balance to the lid portion, extra storage place for small items including mints, butter packets, salt and pepper (or other spice) packets, and even silverware. The stability depressions 124 can also provide indentions to all a user to more easily grasp food containers disposed on the lip portion 101.

The lid wells 110, and the tiers defined within them, and the sauce cup wells 112 can be formed in the lid portion 101 but forming a depression in the top surface of the lid portion 101. For the purpose of discussing FIGS. 2a-2c, the lid wells 110, sauce cup wells 112, or any other wells formed in the lid portion 101 of the food carrier 100 can generally be referred to as “wells” or “wells in the lid portion.” The depression in the top surface of the lid portion 101 can define side walls and a bottom of the wells, and, when sized and shaped to predetermined dimensions, the depression can form a well fit for holding the food containers. In a preferred embodiment, the side walls and bottom surface of the wells in the lid portion will engage a portion of the outer surface of the food container so that the food container rests firmly and securely within the well. The side walls of the well can engage at least a portion of a side wall of a food container and the bottom surface of the well can contact the bottom surface of said food container.

One purpose of the lid portion 101 is to receive and secure food containers having varying sizes and shapes. Each tier 114a-c is configured to receive a specifically sized and shaped food container. The shape and/or size of each food container is preconfigured to fit into and be secured within at least one of the tiers within at least one of the lid wells 110.

In one or more embodiments, bottom engagement 116 can be included on the bottom surface of a tier 114a-c and/or well 110, 112. And shown, the bottom engagement 116 can include a raised portion of the bottom surface of a well that is configured to engage a bottom of a food container. The bottom engagement 116 works best when the food container has a similarly shaped indention in its bottom surface so that it couples with the bottom engagement 116. The bottom engagement 116 provides an added benefit to the food carrier 100 because it prevents the engaged food container from sliding horizontally in relation to the lid portion 101. As shown in FIGS. 2a-c, the top tier 114a can includes a bottom engagement 116b that includes two raised portions on the bottom surface of the top tier 116a. Because the middle tier 116b is disposed in between the first end and the second end of the top tier 116a, the bottom engagement 116b of the top tier 114a can include a first raised engagement toward the first end of the top tier 114a and a second raised engagement toward the second end of the top tier 114a. Also shown, the bottom tier 114c can also include a bottom engagement 116a about its bottom surface. Though not shown, the middle tier 114b can have a bottom engagement about its bottom surface.

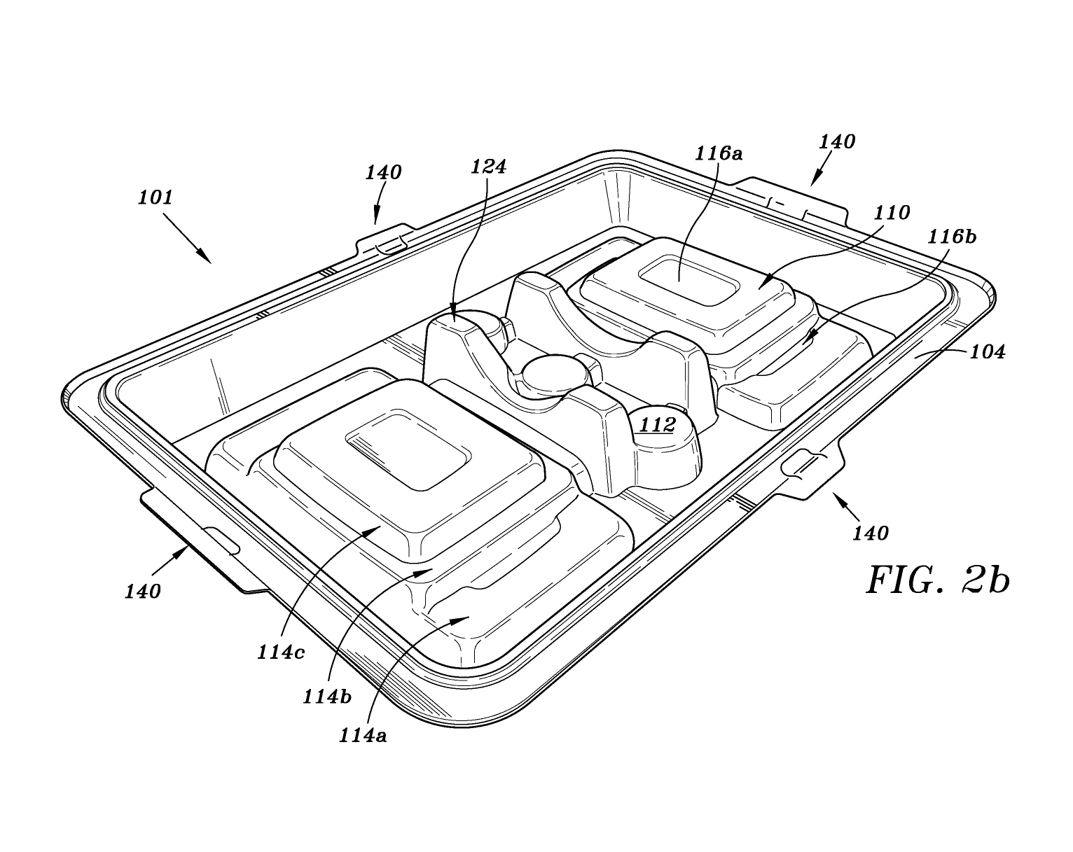

FIGS. 3a-c depict a lid portion 101 having various food containers disposed thereon. In the embodiment shown in the Figures, the top tier 114a is configured to receive a food container with a bottom surface having a relatively large surface area. The middle tier 114b extends downward from the bottom surface and about the center of the top tier 114a. In this configuration, a food container disposed on the top tier 114a will be supported most at a first and second end of the food container. The middle tier 114b is configured to receive a food container with a bottom surface having a relatively smaller surface area than a food container designed to fit onto the top tier 114a. In the configuration shown in the figures, a bottom tier 114c extends downward from the bottom surface and about the center of the middle tier 114b so that the food container disposed on the middle tier 114b will be supported about a perimeter of its bottom surface as it rests on the second tier 114b.

Referring to FIG. 3a-c, for illustration purposes, the two lid wells 110 are the same, each including the three tiers 144a-c. The first lid well is shown as “empty” while food containers are exchanged in the second lid well to illustration the use of each of the three tiers 144a-c. As shown in FIG. 3a, a first food container 204 can be disposed in the lid well 110. The first food container 204 can be disposed in the top tier 114a of the lid well 110 such that the bottom surface of the first food container rests on the bottom surface of the top tier 114a and the side walls of the top tier 114a abut the side walls of the first food container 204 to prevent the first food container from sliding horizontally. In this embodiment, because the middle tier 114b and bottom tier 114c are disposed about the middle of the top tier 114a, the bottom surface of the first food container 204 will primarily engage the top tier 114a about its first end and second end. Additionally, a sauce cup 202 can be disposed in a sauce cup well 112 (three are shown).

As shown in FIG. 3b, a second food container 206 can be disposed in the middle tier 114b of the lid well 110 such that the bottom surface of the second food container rests on the bottom surface of the middle tier 114b and the side walls of the middle tier 114b abut the side walls of the second food container 206. As shown in FIG. 3c, a third food container 208 can be disposed in the bottom tier 114c of the lid well 110 such that the bottom surface of the third food container rests in the bottom surface of the bottom tier 114c and the side walls of the bottom tier 114c abut the side walls of the third food container 208.

Once the food containers and/or sauce cups are placed in the lid portion of the food carrier 100, it may be difficult from a user to then remove the food containers. To solve this problem, the lid portion 101 of the food carrier 100 can also include one or more gripping indentions to allow a user to get his/her fingers around the food container to lift it out of the well within the lid portion 101. Several are shown in the figures, including the gripping indention around each sauce cup well 112 and in the two elongated gripping indentions about the interior of the lid wells 110. In a preferred embodiment, these gripping indentions allow a user to grip the food container about its base so that the user does not have to lift the food container by its lid. This prevents any mess in the even the lid of the food container was to “pop off” during lifting.

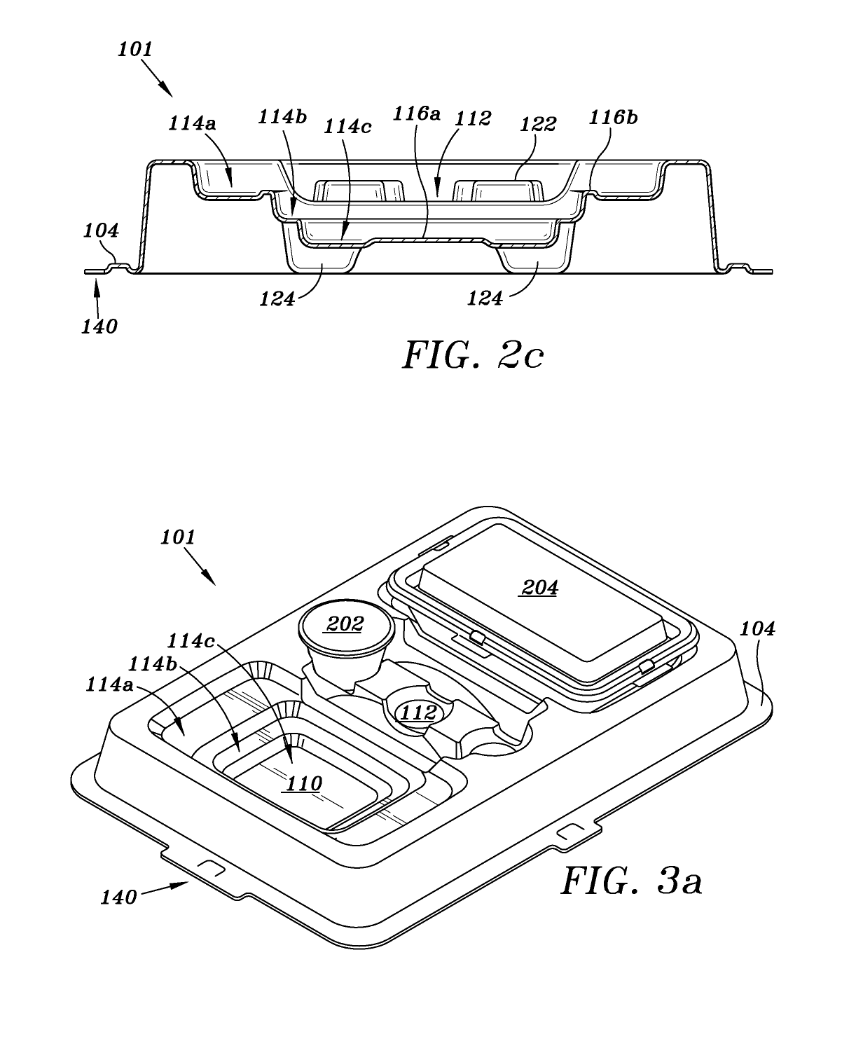

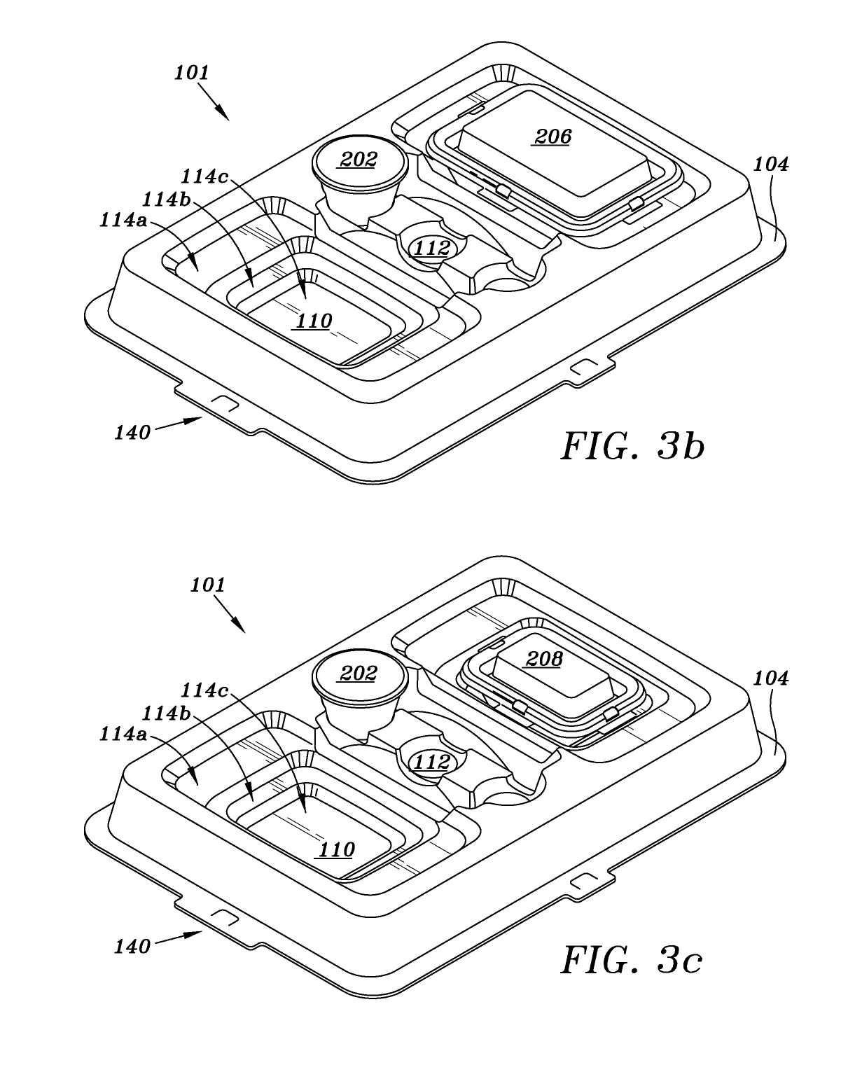

FIG. 4 depicts the base portion 102 of the food carrier 100. FIG. 5 depicts a cross sectional view of the base portion of the food carrier as indicated in FIG. 4. The base portion 102 of the of the food carrier 100 can include one or more base wells 150, and similar to the lid wells 110, the base wells 150 can be configured to receive and secure one or more food containers. The base wells 150 can include side walls configured to abut the outer side walls of a food container, or as shown, at least a portion of the outer side walls of the food container. The base portion 102 can also contain one or more utensil wells 152. The utensil well(s) can be elongated in shape to allow for storage of serving and eating utensils within the food carrier 100. The base wells 150 and/or utensil wells 152 can be defined by the outer wall, or perimeter wall, of the base portion 102 and one or more partition walls 154 extending upward from the bottom of the base portion 102. Similar to the gripping indentions in the lid portion 101, discussed above, one or more gripping indentions can be disposed in the one or more partition walls 154 or within the perimeter wall of the base portion 102 of the wall to allow a user to more easily grip any food containers disposed within the base portion 102.

The food containers can be configured in a variety of sizes and shapes, and can be customized to fit within the food carrier disclosed herein. For best results the sizes and shapes of the food containers should be configured such that each food container fits within at least one of the wells 110, 112 within the lid portion 102 or the wells 150, 152 within the base portion 102.

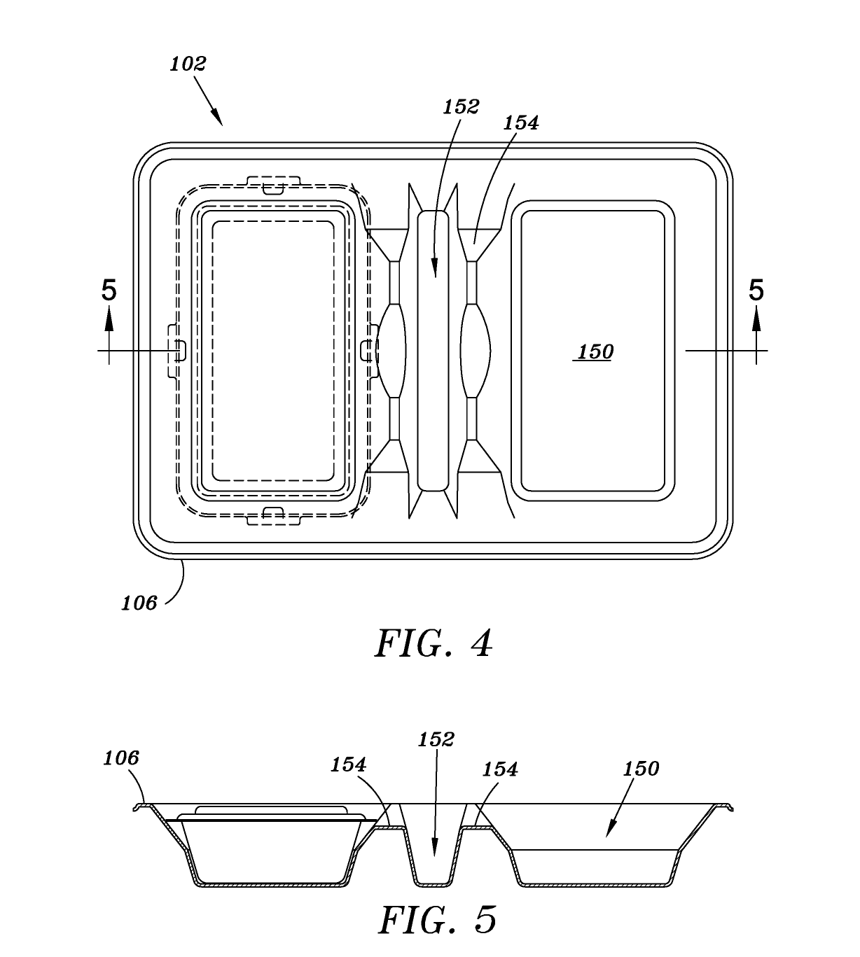

FIGS. 6a-d depicts a variety of example food containers sized and shaped for the food carrier 100. The food containers' primary function is to store food for delivery to a consumer. Therefore, the shapes and sizes of the food containers can be made to reflect the types of food each might contain. For example, FIG. 6a depicts a food container that is relatively large and suitable for larger food items or dishes including a main dish, a large salad, or long vegetables like asparagus. The food container depicted in FIG. 6a is generally rectangular in shape, though it could also be circular, triangular, elliptical, square, or any other geometric shape. FIGS. 6b depicts a food container that is generally square in shape. The food container depicted in FIG. 6b could be relatively medium and/or small in size and suitable for food items or dishes including salads, side dishes, deserts, or bread. FIG. 6c depicts a food container generally referred to as a sauce cup because it is suitable for holding small amounts of a liquid type substance such as salad dressing, condiments, or dipping sauces. The sauce cup is shown and being generally cylindrical in shape, but in an alternative embodiment could be any shape desired. FIG. 6d depicts a food container that is generally rectangular in shape and suitable for food items including hotdogs.

The plurality of food containers allows the food preparer (e.g., the chef in a hotel kitchen) to put each dish of a meal (or a plurality of meals) in a separate food container so that the dishes do not cross contaminate. This is especially beneficial if the food is not going to be consumed immediately. For example, a salad can be placed in a food container and the dressing for the salad can be placed in a sauce cup. The food container containing the salad can be placed in an appropriate lid well and the sauce cup can be disposed in the sauce cup well. The consumer benefits because the sauce is not placed on the salad by the food preparer and therefore does not become “soggy” if the delivery of the salad takes a long time. In another example, spaghetti may be served in a first food container and placed in a base well. Accompanying salad and bread sticks can be placed in second and third food container, respectively, and placed in a lid well. As such, the bread does not become soggy and the salad is not warmed by the spaghetti.

Another benefit of the food carrier disclosed herein is the ease by which full meals can be delivered by a single person and with a decreased risk of spillage. One or more food containers, sauces, condiments, and utensils can be disposed on a single food carrier 100. The food carrier can then be held by a food deliverer as a single unit, getting rid of the need to make several trips for delivery or cramming the food containers into bags which creates an increased risk of spillage of the food.

All components of the food carrier system can be disposable, thereby, when used for hotel room service, eliminating the need for designated kitchen personnel to go around the hotel collecting dirty dishes. In at least one embodiment, one or more of the components of the food carrier system can be made of a recyclable material. In at least one embodiment, one or more of the components of the food carrier system can be made of a biodegradable material.

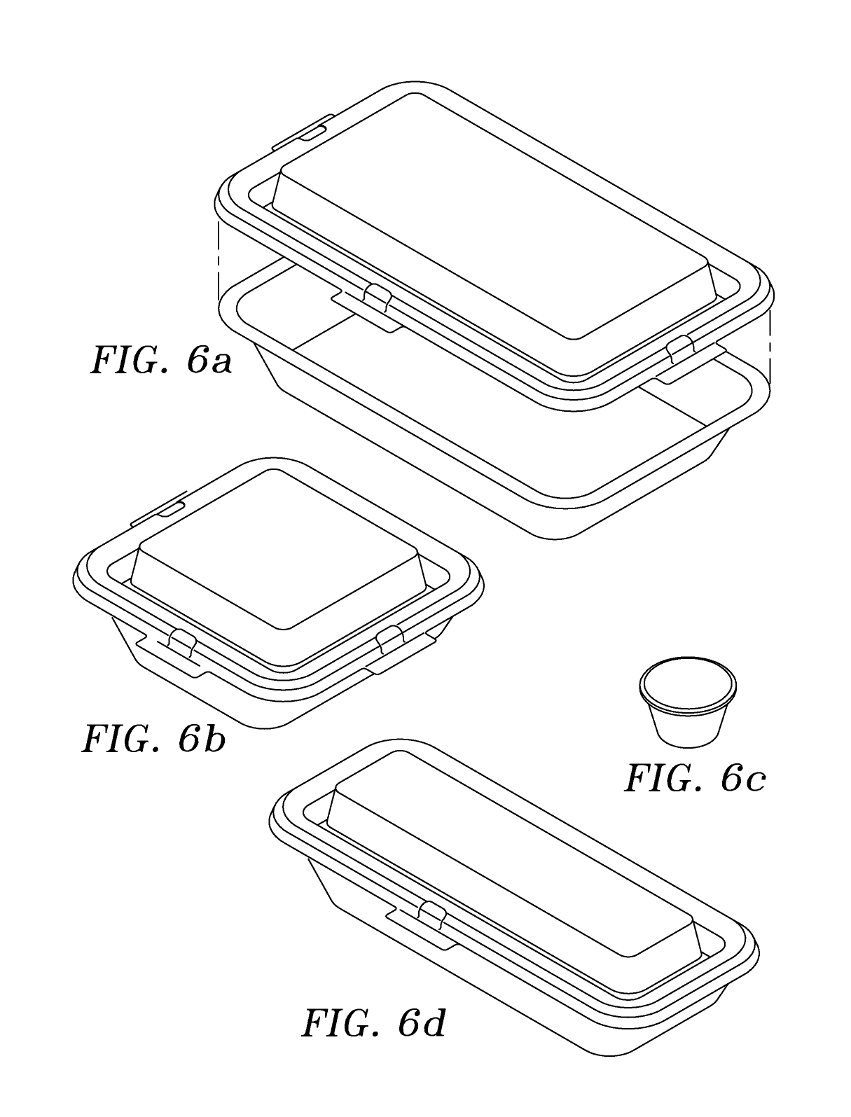

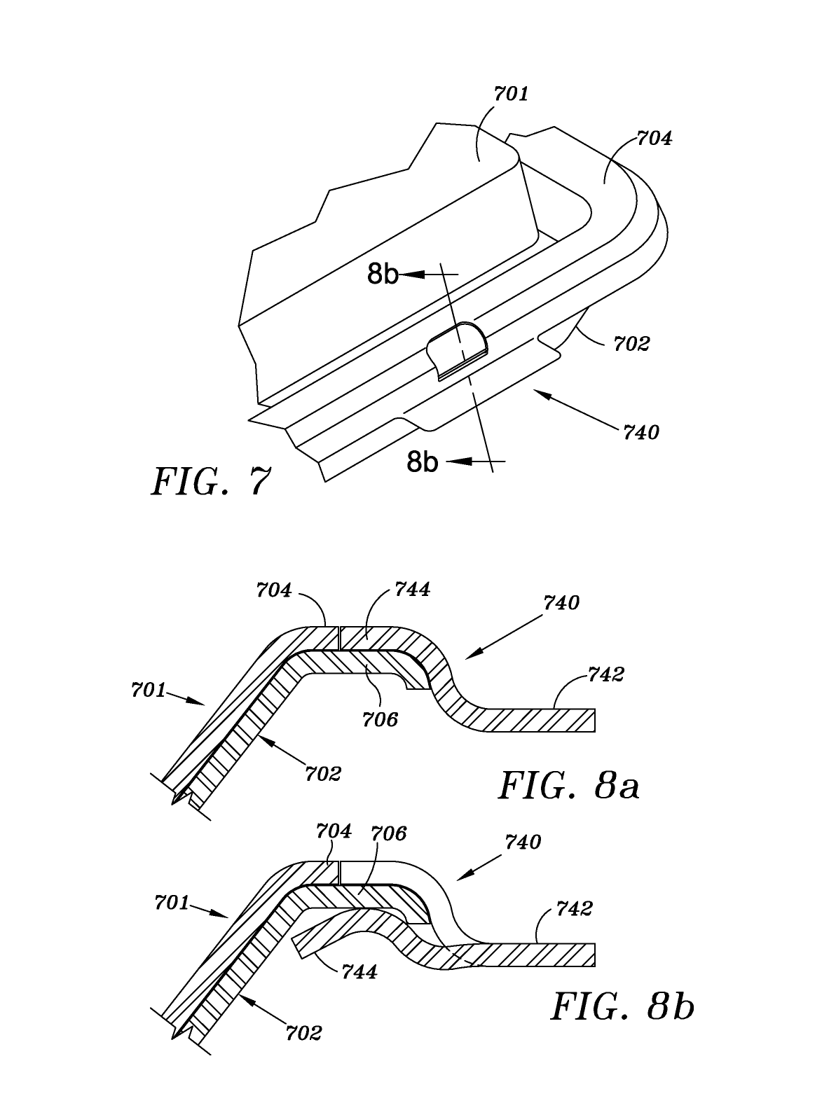

Another component of the food carrier is the securing mechanism to secure the lid portion of a container to the base portion of a container. The securing mechanism provides a means for a user to easily secure the lid and base with a quick maneuver using just one hand, leaving the user's other hand free. FIG. 7 depicts a lid portion 701 and a base portion 702 of a container connected by a securing mechanism 740. FIGS. 8a and 8b depict a cross sectional view of a securing mechanism 740 in an unlocked and a locked position, respectively. The securing mechanism 740 discussed in reference to FIGS. 7 and 8a-b includes any securing mechanism affixed to any container described herein, including, but not limited to, the food carrier, a food container, and/or a sauce cup. The terms “lid” and “base” are general terms used to indicate what can be readily understood by the reader to mean the lid of the container and the base of the container, respectively.

The lip 701 includes a lid rim 704 configured to overlay the base rim 706. The securing mechanism 740 can extend from the lid 701 and include a separation tab 742 and a lock tab 744. When the securing mechanism is not securing the lid 701 to the bae 702, it is generally considered to be in the unlocked position, and as such the lid 701 and base 702 can move freely of one another. The method of securing the lid 701 to the base 702 can include one or more of the following steps: (1) resting the lid 701 on the base 702 so that the lid rim 704 generally rests on the base rim 702; (2) placing the user's index finger on the underside of the separation tab 742; (3) pushing down on the lock tab 744 to separate it from the plane of the lid rim 704; and (4) positioning the lock tab 744 under the base rim 706. Once the lock tab 744 is positioned under the base rim 706, the securing mechanism is in the locked position. For a container having four sides, it might be preferable to have a securing mechanism on each of the four sides to provide best attachment results. In an alternative embodiment, the container can have a securing mechanism on two opposing sides.

Although the present food carrier system has been described with respect to specific details, it is not intended that such details be regarded as limitations on the scope of the food carrier system, except to the extent that they are included in the accompanying claims. It will thus be appreciated that those skilled in the art will be able to devise numerous alternative arrangements that, while not shown or described herein, embody the principles of the food carrier system and thus are within its spirit and scope.

1. A food carrier, comprising:
a base portion;
a lid portion;
a depression in the lid portion defining a lid well comprising two or more tiers; and
a securing mechanism to removably secure the lid portion to the base portion.

2. The food carrier of claim 1, further comprising one or more lid wells disposed on the lid portion, each configured to accommodate a food container.

3. The food carrier of claim 2, wherein each of the one or more lid wells comprises at least two tiers.

4. The food carrier of claim 2, wherein each of the one or more lid wells comprises three tiers.

5. The food carrier of claim 1, wherein one or more food containers are configured to be secured by the one or more tiers of the lid well.

6. The food carrier of claim 1, wherein the lid well comprising a first tier, a second tier, and a third tier, wherein the configuration of the first tier is preselected to complement a first food container, wherein the configuration of the second tier is preselected to complement a second food container, and wherein the configuration of the third tier is preselected to complement a third food container.

7. The food carrier of claim 5, wherein one of the first food container, second food container, or third food container can be disposed in the lid well at a given time.

8. A food carrier system, comprising:
a food carrier, comprising:
a base portion having a bottom and an outer perimeter wall extending from the top at a perimeter thereof;
one or more partition walls extending upward from the bottom of the base portion defining two or more base wells;
a lid portion; and
a first depression in the lid portion defining a first lid well having two or more tiers; and
one or more food containers.

9. The food carrier system of claim 8, wherein the one or more food containers vary in size and shape such that one or more of the food containers fit into one or more of the tiers of the lid well or one of the two or more base wells.

10. The food carrier system of claim 8, wherein the first lid well comprising a first tier, a second tier, and a third tier, wherein the configuration of the first tier is preselected to complement a first food container, wherein the configuration of the second tier is preselected to complement a second food container, and wherein the configuration of the third tier is preselected to complement a third food container.

11. The food carrier system of claim 10, further comprising a second depression in the lid portion defines a second lid well, wherein the second lid well comprising a first tier, a second tier, and a third tier, wherein the configuration of the first tier of the second lid well is preselected to complement a fourth food container, wherein the configuration of the second tier of the second lid well is preselected to complement a fifth food container, and wherein the configuration of the third tier of the second lid well is preselected to complement a sixth food container.

12. The food carrier system of claim 11, wherein one of the first food container, second food container, or third food container can be disposed in the lid well at any given time and wherein one of the fourth food container, fifth food container, or sixth food container can be disposed in the lid well at any given time.

13. A food carrier system comprising:
a food carrier, comprising:
a base portion having a bottom and an outer perimeter wall extending from the top at a perimeter thereof;
one or more partition walls extending upward from the bottom of the base portion defining two or more base wells;
a lid portion having a top and an outer peripheral wall extending from bottom at a perimeter thereof;
a depression in the lid portion defining a lid well comprising a first tier, a second tier, and a third tier,
wherein the first tier of the lid well is configured to receive a food container of a first predetermined dimension,
wherein the second tier of the lid well is configured to receive a food container of a second predetermined dimension, and
wherein the third tier of the lid well is configured to receive a food container of a third predetermined dimension; and
one or more securing mechanism to removably secure the lid portion to the base portion; and
one or more food containers, wherein the one or more food containers are sized to fit into one or more of the first tier of the lid well, the second tier of the lid well, the third tier of the lid well, or one of the two or more base wells.

14. The food carrier system of claim 13, where the food containers are configured to hold and maintain one or more food items during transportation of the food carrier system to a user.

15. The food carrier system of claim 14, wherein the food container includes a base portion and lid with the food items disposed therein and wherein the lid can be removed from the food container for access to the food items therein.
